(19) United States
(12) Patent Application Publication
(10) Pub. No.: US 2026/0352775 A1
(43) Pub. Date: Nov. 5, 2026

(54) BACKGROUND GENERATION

(71) Applicant: Mo-Sys Engineering Limited, London (GB)

(72) Inventors: Michael Paul Alexander Geissler, London (GB); Oliver Augustus Kingshott, London (GB)

(73) Assignee: Mo-Sys Engineering Limited, London, OT (GB)

(21) Appl. No.: 19/118,167

(22) PCT Filed: Oct. 3, 2023
(86) PCT No.: PCT/GB2023/052547

§ 371 Date: Apr. 3, 2025

(30) Foreign Application Priority Data
Oct. 3, 2022 (GB) 2214517.1
Apr. 24, 2023 (GB) 2305985.0

(51) Int. Cl. H04N 5/222; G06F 3/147; H04N 5/275; H04N 9/75; H04N 23/90

(52) U.S. Cl. CPC H04N 5/2228; G06F 3/147; H04N 5/275; H04N 9/75; H04N 23/90

(57) ABSTRACT

A display controller for a video capture system. The display controller includes one or more processors configured to receive an indication of a first location of an active camera and a second location of a non-active camera; receive a definition of a three-dimensional scene; form first and second representations of the scene from the first and second locations respectively; and transmit the first representation to a display wall and the second representation to a production controller.

### BACKGROUND GENERATION

This invention relates to generating backgrounds in images captured by multiple cameras.

In filming studios or sets it is becoming increasingly common to shoot video of subjects against a background that is displayed on an array of display panels. The array is commonly known as a display wall or an LED wall. This approach can provide a number of advantages over conventional approaches to filming. For example, the background can readily be changed to suit different filming requirements, and because the background is illuminated it can cast light on the subjects, making the subjects appear more natural than with a non-illuminated background.

The display wall displays a two-dimensional image, whereas the background typically depicts a three-dimensional scene. For that reason the image shown on the display wall can be generated so as to depict the scene as it would appear from a desired location. That location is typically selected to correspond to the location of the camera that is in use. Then that camera can capture images of the subjects against a view of the scene that appears realistic from the point of view of that camera.

When multiple cameras are available in the filming studio, a producer can typically switch between cameras so as to capture images from different locations. The producer may want to see what the image will look like from a new camera before switching to it. That cannot be done accurately by simply viewing images captured by the new camera that have the background appropriate to the currently active camera. The reason for that is that the three-dimensional scene would appear different from the position of the new camera when projected on to two dimensions. Images captured by the new camera when the background is appropriate to the currently active camera may appear to have a distorted background.

One way to address to this is to cause the display wall to successively display backgrounds appropriate to each of the available cameras, and to synchronise each camera with the display wall so that each camera captures images only when the respective background is being displayed. However, since the display wall typically has a relatively high resolution, this can require a large amount of data processing to generate all the background images, and much bandwidth to transmit those images successively to the wall.

There is a need for an improved approach to operating display walls so as to allow producers and similar operators to realistically envisage what would be seen when any of multiple cameras is active.

According to one aspect there is provided a display controller for a video capture system, the display controller comprising one or more processors configured to: receive an indication of a first location of an active camera and a second location of a non-active camera; receive a definition of a three-dimensional scene; form first and second representations of the scene from the first and second locations respectively; and transmit the first representation to a display wall and the second representation to a production controller.

A system may comprise such a display controller together with the display wall and the production controller.

The display controller may be configured to cause the display wall to alternately display (i) the first representation and (ii) a monochrome image of a predetermined colour or a complementary image of the first representation. The production controller may be configured to perform chroma-key processing to replace portions of an image received from the non-active camera that are of the predetermined colour with corresponding portions of the second representation to form a modified image.

The first representation may be of higher resolution than the second representation.

Such as system may comprise the active camera and the non-active camera. The active camera and/or another part of the system may be configured to capture frames when the first representation is displayed by the display wall and not when the monochrome image is displayed and the non-active camera is configured to capture frames when the monochrome image is displayed by the display wall and not when the first representation is displayed. Such selective capture may be done by discarding unwanted frames.

The display controller may be configured to cause the display wall to alternately display (i) the first representation, (ii) a monochrome image of a predetermined colour and (iii) a monochrome image of a colour complementary to the predetermined colour. The production controller may be configured to perform chroma-key processing to replace portions of an image received from the non-active camera that are of the predetermined colour with corresponding portions of the second representation to form a modified image.

The active camera may be configured to capture frames when all of the first representation, the monochrome image of a predetermined colour and the monochrome image of a colour complementary to the predetermined colour are displayed. The non-active camera may be configured to capture frames when the monochrome image is displayed by the display wall and not when the first representation is displayed.

The display wall may comprise a local controller responsive to a command message to cause the display wall to display a monochrome image of a predetermined colour. The display controller may be configured to cause the display wall to display the monochrome image of a predetermined colour by transmitting such a command. The command message may be of a form that does not contain pixel mapping data for sub-parts of the image.

The system may comprise a control terminal operable with the production controller. The production controller may be configured to output to the control terminal (i) an image captured by the active camera including the first representation as a background and (ii) the modified image. The production controller may be responsive to input from the control terminal to render the active camera henceforth the non-active camera and to render the non-active camera henceforth the active camera.

The production controller may be configured to transmit output from the current active camera as production output.

Each camera may comprise apparatus configured to determine the location of the camera and to transmit that location to the display controller.

According to a second aspect there is provided a control apparatus for controlling a display wall for operation as a studio backdrop, the display wall being composed of multiple display panels, the control apparatus comprising an input and one or more processors configured to: in response to receiving at the input image data representing pixel regions of an image, cause the display panels to collectively display that image; and in response to receiving at the input a command message of a predetermined form, cause the display panels to collectively display a monochrome image of a predetermined colour.

The image data may represent in compressed form the pixels of an image. The command message may not represent in compressed form the pixels of an image.

According to a third aspect there is provided a method for estimating the location of a subject in a video feed, the method comprising: providing a display wall behind the subject; forming a background image adapted to the location of an active camera; causing the display wall to alternately display the background image and a monochrome image of a predetermined colour; capturing using the active camera a video feed of the subject by forming a plurality of frames at times when the background is displayed; capturing an image of the subject when the monochrome image is displayed; and estimating the location of the subject by processing the captured image to determine regions therein that are not of the predetermined colour.

The said step of capturing an image of the subject may be performed by the active camera.

According to a fourth aspect there is provided a method of generating a background for a display wall, the method comprising: providing a display wall behind a subject; positioning at least two cameras in front of the subject, displaying a background having a first perspective on the display wall, viewing the background with the first perspective from a first camera located at a first location and with a second camera located at a second location, applying a transformation to generate a background having a second perspective, and adapting a video feed from the second camera to replace regions in the video feed representing the background having the first perspective with regions representing the background having the second perspective.

The first perspective is from the first location. The second perspective is from the second location.

The method may further comprise subsequently switching to display the background having the second perspective on the display wall and replacing regions in a video feed from the first camera.

The first and second backgrounds captured by a first and second camera may be the appropriate perspective for each respective camera, as determined by the position of the cameras relative to the background and subject.

The perspective transformation may be performed by inputting a first image of a scene and a distance parameter into an artificial intelligence system. Rendering software may be used to apply a transformation to a first image of a scene and produce a second view of the scene.

The method may further comprise displaying a complementary image on the display wall of the background having the first perspective and/or displaying a complementary image on the display wall of the background having the second perspective.

The complementary image(s) are preferably displayed between the background image. The complementary image is preferably displayed for the same duration as the respective background image. The complementary image and background image may be shown alternately for a limited duration so as to appear to cancel each other to an observer of the display wall.

The present invention will now be described by way of example with reference to the accompanying drawings. In the drawings:

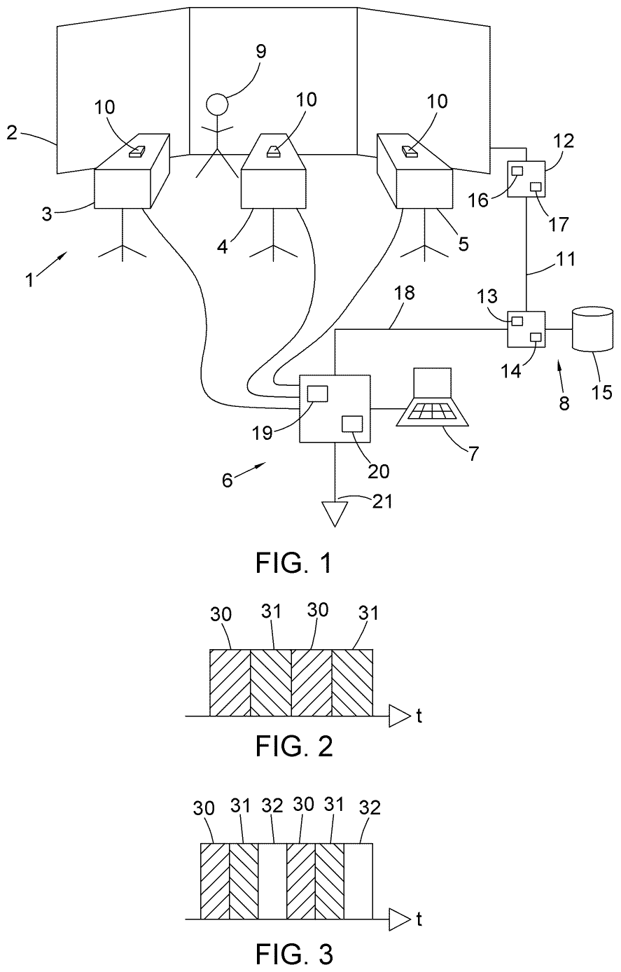

FIG. 1 shows a filming studio and associated processing apparatus.

FIG. 2 shows a first frame schedule.

FIG. 3 shows a second frame schedule.

FIG. 1 shows a studio space or set indicated generally at 1. To the rear of the studio space is a display wall 2. The display wall is positioned to display images into the studio space. Multiple cameras 3, 4, 5 are positioned and directed so as to image some or all of the studio space and some or all of the display wall.

A production control system 6 receives images captured by the cameras. The production control system has a user interface input apparatus 7, such as a keyboard or a touchscreen. As will be described further below, a user of the production control system can operate the user interface apparatus 7 to select the output of one of the cameras to form a production output stream. The production output stream can be stored and/or output, for example as a broadcast feed.

A display controller 8 forms an image output stream which drives the display wall.

One or more subjects 9 are located in the studio space. The subjects may be humans, animals or inanimate objects such as props. The cameras may be located and directed so as to image one or more of the subjects against a background displayed on the display wall.

One or more of the cameras may be equipped with apparatus 10 for estimating the location of the camera in the studio space.

The display wall may be constituted in any convenient way. For example, it may be formed of an array of multi-pixel display panels, or it may be a screen for displaying images that are projected on to the screen. The display wall receives image input from the display controller via a data link 11. Conveniently the data link may be a wired link. Alternatively it may be a wireless data link. To reduce the amount of data that needs to be sent over the data link the display wall may have a local processor 12 which is arranged to decompress data sent from the display controller. Alternatively the display controller may be located locally to the display wall. The local display controller 12 may have a processor 16 and a memory 17. The memory stores code executable by the processor to cause the local display controller to execute the functions described of it herein. The memory may also store definitions of predetermined frames, as will be discussed further below.

The front, display surface of the display wall may be planar or non-planar. In one example it may be formed of a plurality of adjoining planes that wrap to some extent around the studio space. The display surface may have a vertical extent. It may be parallel to a vertical axis or it may be sloped or curved relative to the vertical.

The display controller 8 comprises a processor 13, a program store 14 and a scene data store 15. The program store and the scene data store may share the same physical memory. The program store stores in non-transient form code executable by the processor to perform the functions described of it herein. The scene data store stores in non-transient form scene data that defines a three-dimensional scene. The display controller can process the scene data to form an image of the scene from a given position. To do this it may use suitable rendering software such as Unreal Engine™. The scene as defined by the scene data may be constant over time or may change over time. By changing over time the scene may enable the background as displayed on the display wall to portray changing backgrounds such as trees moving in a breeze or waves crashing on a shoreline. In operation, the display controller receives a location in the studio for which it is to generate a background. The way in which it receives this location will be described below. In practice the location can be supposed to be the location of an active camera in the studio. The display controller then generates an image of the scene data, for the scene in its current state, as it would appear from the location. The display controller then transmits that image, optionally in a compressed form, to the display panel, to cause the display panel to display that image.

In practice, the display controller may provide a series of video frames to the display panel, each frame being an image representing the scene specified by the scene data as viewed from the specified position. The position may change over time, for example if the active camera moves or if a different camera is activated.

Once the image, which may be a still image or a frame of a video feed, is displayed on the display panel, the active camera can capture an image of the subjects against the displayed image. That captured image can then be passed to the production control system 6. If the position used by the display controller to generate the image was the position of the active camera then the displayed image will give a proper representation of the stored scene with the subjects in the foreground.

The locations of the cameras may be fixed. For example, a camera may be fixedly mounted to the floor or another fixed part of the set. Alternatively one or more of the cameras may be moveable during filming. For example, a camera may be mounted on wheels. The locations of the cameras may be determined in advance, for example by manual measurements, and input to the display controller. Alternatively, one or more of the cameras, and/or the set, may be provided with apparatus 10 whereby the location of such camera(s) may be determined. That apparatus may, for example, be a StarTracker system as commercially available from Mo-Sys Technology Limited, an ultra-wideband locationing system or any other suitable system. Locations determined by such a system can be passed from time to time, e.g. in real time, to the display controller. The display controller is then able to use such locations to form an image of the scene suitable for the point of view of that camera. With the locations of all the cameras available to it the display controller can form images of the scene suitable for all their points of view. The locations may be transmitted to the display controller by any suitable wired or wireless mechanism.

A trained neural network could be used to estimate which regions in a video stream captured by a secondary camera represent a foreground and/or a background. Regions that are not estimated to be foreground may be deemed to be background. The background regions may be the regions that are replaced in the video stream with images representing the background image from the point of view of the secondary camera.

As indicated above, the display controller transmits to the display wall an image for display. When moving or video images are to be displayed by the wall, the display controller may transmit successive frames, or information defining successive frames such as a set of differences from a previous or reference frame. When still images are being displayed, the display controller may transmit successive identical frames, as if it were video. Alternatively it may transmit an image and the display wall or the memory 17 local to the wall it may cache that image and enable the wall to continue to display it until the display controller transmits a replacement image to the display wall.

The production controller informs the display controller which camera is currently live. That is the camera whose captured images are currently being used to form the production video stream. The display controller uses the location of that camera as the location for generating the image(s) it transmits to and that are to be displayed by the display wall. When a different camera becomes live, that change is similarly notified to the display controller and in response the display controller begins generating and transmitting the image(s) for display from the location of that camera.

The location of each camera may be provided in any suitable frame of reference. Conveniently it may be with reference to an origin defined in the film studio/set. For ease of calculation, that location may optionally be coincident with a part of the display surface of the wall.

The operation of the system to provide representative views at the production controller of the expected video when each camera is live will now be described.

The display controller can operate in a mode in which it causes the display wall to alternately display (a) an image/frame determined as described above, that is an image depicting the stored scene from the point of view of the currently live camera (30 in FIG. 2) and (b) an image comprising a solid block of a predetermined colour (31 in FIG. 2). The former image will be referred to as the live image. The latter image will be referred to as the chroma-key image. The chroma-key image may be entirely composed of the predetermined colour. Alternatively it may have the block of colour in its central part and a representation of the stored scene in its peripheral part.

The block of colour may occupy more than 50% and conveniently more than 80% of the displayed image. Conveniently the block may be green or blue, as are commonly used for chroma-keying. The display controller transmits data to the display wall to cause it to display the live image and the chroma-key image alternately. This is illustrated in FIG. 2, which shows the series of images displayed. The live image 30 and the chroma-key image 31 are displayed alternately.

The frequency with which the live image and the chroma-key image are displayed can be selected in dependence on the performance of the cameras that are in use. In one example, the live image and the chroma-key image are displayed at a capture frequency of the cameras, or an integer multiple thereof. For example, if the cameras can capture images at 100 Hz then the live image may be displayed 100 times per second, interspersed by the chroma-key image being displayed. In this embodiment the active camera may be synchronised so as to capture images only when the live image 30 is displayed. The other cameras may be synchronised so as to capture images only when the chroma-key image 31 is displayed.

The display controller can operate in a mode in which it causes the display wall to alternately display (a) an image/frame determined as described above, that is an image depicting the stored scene from the point of view of the currently live camera and (b) an ‘inverse image’/frame comprising complementary colours to the previously displayed image. A complementary image is used herein to mean an image having at least one of complementary colours and inverse brightness as a proportion of total display brightness, relative to a displayed image. For example, an image of a forest scene having mostly dark green and brown colours will have a complementary image having pale pink and blue colours. The complementary image may be partially an inverse of an image and partially a solid chroma-key colour. For example, a complementary image of a foreground and a solid colour in a region of sky at the top of the image.

Further, the display controller can display images of the stored scene from the point of view of each camera, this will be discussed in more detail below. The display controller can operate in a mode in which it causes the display wall to alternately display a) an image from a first perspective, b) a complementary image from the first perspective, c) an image from a second perspective, and d) a complementary image from the second perspective. The order of display of each of (a) to (d) may be any order, it is not necessarily in the sequence a, b, c, d.

Each camera will have a field of view or frustum. Each camera may have a direction sensor to detect the direction in which its field of view is directed and a lens sensor to sense the state of its lens and therefore the scope of its field of view. From these the frustum of the camera can be estimated. Such data can be provided to the display controller. The display controller may then control the operation of the display wall such that display within the frustum of the active camera is different from that outside. For example, the monochrome chroma key colour may be displayed in all time segments outside the frustum of the active camera.

The display controller may employ any convenient route to cause the live image and the chroma-key image or complementary image to be alternated. In one example, it may transmit both the live image and the chroma-key image as pixel or compressed pixel image data. In aggregate the images may be transmitted at twice the capture frequency of the cameras. To reduce the bandwidth required to provide the image data to the display wall, in an alternative approach a memory local to the display wall may pre-store the chroma-key image. Then when the chroma-key image is to be displayed the display may simply transmit a command to the display wall to display the chroma-key image. Multiple chroma-key images, for instance in different colours, may be stored at the display wall, and their display triggered by corresponding commands from the display controller. Thus, it is envisaged that one or more panels of the display wall, or a controller local to the display wall may pre-store in a local memory 17 a chroma-key image and be responsive to a predetermined command to cause that image to be retrieved from its storage and displayed.

The cameras are synchronised to the displaying of the live and chroma-key or complementary images. The live or active camera is caused to capture images when the live images are being displayed. The other camera(s) is/are caused to capture images when the chroma-key or complementary images are being displayed. This may be achieved in multiple ways. One option is for the production controller to signal each camera as to whether that camera is currently live or not, and for the cameras to be synchronised with the display controller, either by virtue of a common clock or by transmitting synchronisation signals between the devices. Then a processor at each camera can select whether to capture images in phase with the live images or in phase with the chroma-key images, in dependence on the state of that camera as live or not.

The display controller generates images of the stored scene from the point of view of each camera; that is from the position of each camera as known to the display controller. That information is passed to the production controller via link 18. The production controller has a processor 19 and a memory 20 storing in non-transient form code executable by the processor to cause the production controller to perform the functions described of it herein. The production controller performs colour-key replacement in each frame received from the non-live cameras using the images received from the display controller. In each frame received from a camera the production controller replaces regions coloured in the colour of the chroma-key image (e.g. a green) with the corresponding regions of the image received from the production controller for the respective camera. The resulting composite images can then be displayed on the production control user interface 7, together with the image received from the active camera without that image having undergone colour keying. This happens with successive frames captured by the cameras, so the production control user interface can display video streams of which one or more have been modified by colour keying and one is from the active camera and has not been modified by colour keying. From these images an operator using the production control user interface can select a camera to form an image or video stream to be output as an output feed 21. If a camera is selected that is not the currently active camera then that is signalled to the display controller 8. The display controller 8 then forms images for display on the wall that are appropriate for the position of the new active camera. It also transmits images directly to the production controller that are appropriate for the position of the formerly active camera, so that they can be used for colour-key replacement. The synchronisation of the newly and formerly active cameras are also changed so that the newly active camera captures images 30 and the formerly active camera captures images 31.

A trained neural network may be used to estimate which regions in a generated image of a scene represent a foreground and/or background. The identified background regions may be replaced in the video stream with the background image from the perspective of a currently non-active camera. The trained neural network may be integrated with a processor of the display controller or provided separately in a suitable processor.

The active camera is sometimes termed the on-air camera. It is the camera whose images are currently forming the output video stream of the system. The other cameras may be actively capturing video, for example to supply the production controller with feeds that can be used to anticipate what the output stream would look like if one of those cameras were designated as active.

The images provided by the display controller to the production controller for use in colour keying can conveniently be of lower resolution than the images supplied to the display wall. This can significantly reduce the processing needed at the display controller.

Another application of the setup described with respect to FIG. 1 is the generation of multiple perspectives of a background image for the simulation of a scene when capturing from more than one camera. The display wall 2 can display a first image of a scene from a first perspective. This image may be computer generated, for example rendered as described above. A first camera 3 captures the displayed scene on the display wall 2 and any subject(s) 9 positioned between the display wall and camera. A second camera 4 is located in a different location to the first camera 3. The image of a scene displayed on the display wall, when viewed from the position of the second camera 4, may appear distorted because the perspective of the scene is not appropriate for the angle of the camera. In a multiple camera studio setup, the fact a display wall is being used rather than a 3D set may be more apparent due to this perspective-distortion effect.

The display controller can operate in a mode in which it causes the display wall to display (a) an image of a scene from a first perspective, that is an image depicting the scene from the point of view of a first camera and (b) an image of the scene from a second perspective, that is an image depicting the scene from the point of view of a second camera. The display controller may operate in a manual mode where the perspective of the background image is changed by an operator. The background image on the display wall may be changed in dependence on which camera is active, for example which camera is capturing a recording. The display controller may be configured to display a rendered image from a perspective that is not being displayed on the display wall. An operator can view the display of an alternative perspective shown on the display controller and select this background to be displayed on the display wall 2.

As discussed above, in order for the system to generate an image stream from the point of view of a camera that is not the active camera, the system can (a) estimate which parts of images captured by the non-active camera represent background, (b) generate a background as it would be seen from the point of view of the non-active camera and (c) replace in the images the regions estimated as background with the appropriate parts of the generated background. One way to estimate which parts of the images represent background is to display an image of a known single colour as the background from time to time, and detect that colour in the images. The colour may be a chroma-key colour. Another way to estimate which parts of the images represent background is as follows. The system estimates what a background generated to look correct from the point of view of the active camera, and displayed on the display wall, would look like when viewed from the point of view of the non-active camera. This may, for example, involve appropriate geometric and lens transformations to account for the changes in point of view and lens characteristics. Then the system can perform an image matching operation to detect the transformed image in the images captured by the non-active camera, and in that way estimate the background regions of the images captured by the non-active camera.

FIG. 3 shows an alternative set of images that can be displayed. In this example an additional set of images 32 is displayed. Images 32 are formed by the display controller so as to be chromatically complementary to images 31. That means that the active camera can capture a frame over a whole repeat cycle comprising a frame 30, a frame 31 and a frame 32. Because frame 32 is complementary to frame 31 the two will cancel each other and the resulting captured image background will correspond to frame 30 only. This can reduce the precision to which the active camera needs to be synchronised to image 30. Frames 31 and 32 are conveniently of the same duration.

The display controller can also operate to cause the display wall to display a) an image from a first perspective, b) a complementary image from the first perspective, c) an image from a second perspective, and d) a complementary image from the second perspective. In this scheme, the active camera can capture a frame when the image from the first perspective is displayed. A second camera can capture a frame when the image from the second perspective is displayed. A third camera may have a higher frame rate and capture more than one of the alternating images.

When the system is in operation, at least two cameras are capturing video or still images of a scene. The background of the scene is provided by a display screen or a wall, which may be formed of multiple display screens. Instead of using display screens, a background may be projected on to a backdrop such as a white wall. The cameras are operated so that they capture images at different times. During video operation the cameras may each capture images at, for example, 50 Hz, 60 Hz, 100 Hz or 120 Hz. The cameras are configured so that they capture images out of phase, meaning that their capturing is interlaced. This means that the display screen (or alternative) can be operated so as to display different backgrounds for the respective cameras. One or more processors can control the capture timing of the cameras, the image to be shown as the background at any time, and any post-processing of the captured images. The processors may be configured to perform as desired by suitable software, which may be stored in non-transient form on a suitable data carrier. The location of each camera relative to the screen, and the direction of the point of view of each camera (i.e. the centreline of its field of view projected perpendicular to the image plane of the camera), may be known to the processors. The location and point of view may be determined automatically using known camera location trackers or may be provided manually. The processors may have access to a definition of a scene, for instance as a 3D model, and may be capable of transforming that model to form a 2D image that represents that scene viewed from a particular point and in a particular direction.

Some modes of operation of the system will now be described. The cameras will be referred to as A and B.
1. When camera A is capturing an image, the screen is caused to display an image that is the scene as it would be seen from camera A (i.e. appropriate to the position and point of view of camera A), and when camera B is capturing an image, the screen is caused to display an image that is the scene as it would be seen from camera B (i.e. appropriate to the position and point of view of camera B). This means that each camera will capture an image that appears to be proper to the intended background.
2. As 1, except that in addition, during a time when camera A is not capturing an image and camera B is not capturing an image the screen is caused to display an image that is a complementary colour image of the image displayed for camera B. This may have the additional advantage that for a person viewing the screen directly, the image for camera B is in effect cancelled, and any perception of flicker is reduced.
3. As 1 or 2 except that the image for camera B is a single colour image, e.g. green or blue, suitable for chroma key post processing.

When display walls are being used as a background, it can be advantageous to know the location of subjects in front of the wall. Then specific forms of processing can be done to improve the quality of imaging in the periphery around the subjects in the output images. Examples may include anti-aliasing or displaying the background image/stream only in a rim around the subject and performing chroma-key replacement elsewhere. To use these techniques it is useful to estimate the location of the subjects from the point of view of the active camera. One way to do this would be to use a sensor, e.g. a LIDAR sensor, on the active camera. This requires additional equipment. Another approach would be to compare the image as commanded to be displayed on the wall with the image captured by the active camera. Regions of difference between the two may be considered to correspond to the subject. This can be difficult to do reliably in some practical situations because of the level of detail in the background image. In the system described above, the active camera may capture an image when frame 31 or 32 is displayed. That frame may not form part of the image feed from the camera that may generate the output feed at 20. Instead it may be passed to a suitable processor for use to detect the position of the subject. Since the background displayed in frames 31 and 32 is monochromatic, detecting the position of the subject may be easier and more reliable.

In the description above, units 6, 8 and 12 have been described as separate units. In practice, the processing tasks may be distributed in any convenient way between one or more physical processing devices which may each be local or remote from the studio 1.

Where it is desired for one camera to capture images excluding a certain time segment of what is shown on the display wall, that may be done by the camera being controlled not to sense images or frames during that time or by it sensing images or frames during that time and the images or frames sensed during that time being discarded.

The display wall may be provided by any suitable technology, for example a matrix of display screens such as LED screens or by projection onto the front or rear of a projection screen.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

The phrase “configured to” or “arranged to” followed by a term defining a condition or function is used herein to indicate that the object of the phrase is in a state in which it has that condition, or is able to perform that function, without that object being modified or further configured.

1. A display controller for a video capture system, the display controller comprising one or more processors configured to:
receive an indication of a first location of an active camera and a second location of a non-active camera;
receive a definition of a three-dimensional scene;
form first and second representations of the scene from the first and second locations respectively; and
transmit the first representation to a display wall and the second representation to a production controller.

2. A video capture system comprising a display controller as claimed in claim 1 and the display wall and the production controller.

3. The video capture system as claimed in claim 2, wherein:
the display controller is configured to cause the display wall to alternately display (i) the first representation and (ii) a monochrome image of a predetermined colour or a complementary image of the first representation; and
the production controller is configured to perform chroma-key processing to replace portions of an image received from the non-active camera that are of the predetermined colour with corresponding portions of the second representation to form a modified image.

4. The video capture system as claimed in claim 3, wherein the first representation is of higher resolution than the second representation.

5. The video capture system as claimed in claim 3, comprising the active camera and the non-active camera and wherein the active camera is configured to capture frames when the first representation is displayed by the display wall and not when the monochrome image is displayed and the non-active camera is configured to capture frames when the monochrome image is displayed by the display wall and not when the first representation is displayed.

6. The video capture system as claimed in claim 2, wherein:
the display controller is configured to cause the display wall to alternately display (i) the first representation, (ii) a monochrome image of a predetermined colour and (iii) a monochrome image of a colour complementary to the predetermined colour; and
the production controller is configured to perform chroma-key processing to replace portions of an image received from the non-active camera that are of the predetermined colour with corresponding portions of the second representation to form a modified image.

7. The video capture system as claimed in claim 6, comprising the active camera and the non-active camera and wherein the active camera is configured to capture frames when all of the first representation, the monochrome image of a predetermined colour and the monochrome image of a colour complementary to the predetermined colour are displayed; and the non-active camera is configured to capture frames when the monochrome image is displayed by the display wall and not when the first representation is displayed.

8. The video capture system as claimed in claim 3, wherein the display wall comprises a local controller responsive to a command message to cause the display wall to display a monochrome image of a predetermined colour and the display controller is configured to cause the display wall to display the monochrome image of a predetermined colour by transmitting such a command.

9. The video capture system as claimed in claim 3, comprising a control terminal operable with the production controller and wherein:
the production controller is configured to output to the control terminal (i) an image captured by the active camera including the first representation as a background and (ii) the modified image; and
the production controller is responsive to input from the control terminal to render the active camera henceforth the non-active camera and to render the non-active camera henceforth the active camera.

10. The video capture system as claimed in claim 3, wherein the production controller is configured to transmit output from the current active camera as production output.

11. The video capture system as claimed in claim 5, wherein each camera comprises apparatus configured to determine the location of the camera and to transmit that location to the display controller.

12. The video capture system as claimed in claim 2, wherein:
the display controller is configured to cause the display wall to display (i) the first representation, (ii) the second representation; wherein the second representation is transmitted to the display wall for capture by a second camera.

13. A control apparatus for controlling a display wall for operation as a studio backdrop, the display wall being composed of multiple display panels, the control apparatus comprising an input and one or more processors configured to:
in response to receiving at the input image data representing pixel regions of an image, cause the display panels to collectively display that image; and
in response to receiving at the input a command message of a predetermined form, cause the display panels to collectively display a monochrome image of a predetermined colour.

14. The control apparatus as claimed in claim 13, wherein the image data represents in compressed form the pixels of an image.

15. (canceled)

16. (canceled)

17. A method of generating a background for a display wall, the method comprising; providing a display wall behind a subject; positioning at least two cameras in front of the subject, displaying a background having a first perspective on the display wall, viewing the background with the first perspective from a first camera located at a first location and with a second camera located at a second location, applying a transformation to generate a background having a second perspective, and adapting a video feed from the second camera to replace regions in the video feed representing the background having the first perspective with regions representing the background having the second perspective.

18. The method as claimed in claim 17, further comprising capturing the background with the first camera.

19. The method as claimed in claim 17, further comprising displaying the background having the second perspective on the display wall and capturing the background having the second perspective from the second camera.

20. The method as claimed in claim 17, further comprising displaying a complementary image on the display wall of the background having the first perspective and/or displaying a complementary image on the display wall of the background having the second perspective.
